(19) United States
(12) Patent Application Publication
(10) Pub. No.: US 2015/0178963 A1
(43) Pub. Date: Jun. 25, 2015

(54) GRAPHICAL ANALYSIS SYSTEM AND GRAPHICAL ANALYSIS METHOD

(71) Applicant: AU Optronics Corporation, HSIN-CHU (TW)

(72) Inventor: Yi-Hsin LU, HSIN-CHU (TW)

(21) Appl. No.: 14/451,865

(22) Filed: Aug. 5, 2014

(30) Foreign Application Priority Data
Dec. 25, 2013 (CN) 201310726085.7

(51) Int. Cl. G06T 11/20; G06F 3/0486

(52) U.S. Cl. CPC G06T 11/206; G06F 3/0486

(57) ABSTRACT

A graphical analysis system and a graphical analysis method are disclosed. The graphical analysis system includes a display device, a receiving module, and a control module. The display device is configured to display a first graph, a second graph, and a graph comparison area, in which the display device displays the first graph according to first data and displays the second graph according to second data. The receiving module is configured to receive a first and second input commands. The control module is configured to respond to the first and second input commands. When the first and second input commands are configured to drag and drop the first graph and the second graph into the graph comparison area respectively, the control module controls the display device to display a third graph and display the corresponding data of the first data and the second data in juxtaposition in the third graph.

### RELATED APPLICATIONS

This application claims priority to Chinese Patent Application Serial Number 201310726085.7, filed Dec. 25, 2013, which is herein incorporated by reference.

### BACKGROUND

1. Technical Field

The present disclosure relates to a graphical analysis system and a graphical analysis method thereof. More particularly, the present disclosure relates to the graphical analysis system which is able to drag and drop graphs and the graphical analysis method thereof.

2. Description of Related Art

With the rapid development of electronic technology, users can use various graphical analysis tools to analyze data by showing the analyzed results in the graphs.

Generally, existing graphical analysis tools provide effective techniques which can present a great quantity of data in the form of graphs, to allow users to easily organize data while burdens of analyzing a great quantity of data are reduced.

However, although lots of functions are included in the graphical analysis tools and the graphical analysis tools are capable of accurately calculating a great quantity of data and converting data into graphical forms, it is difficult to provide an accurate method of comparison between plotted graphs; the graphical analysis tools can not directly present the differences of data between different data groups in graphical forms, and thus manual calculations are still required, thereby wasting time and are likely to result in deviations in calculated results due to human error.

### SUMMARY

The disclosure provides a graphical analysis system and a graphical analysis method thereof. An aspect of the present disclosure is a graphical analysis system. According to an embodiment of the present disclosure, in which the graphical analysis system includes a display device, a receiving module, and a control module. The display device is configured to display a first graph, a second graph and a graph comparison area, in which the display device displays the first graph according to first data and displays the second graph according to second data. The receiving module is configured to receive a first input command and a second input command. The control module is configured to respond to the first input command and the second input command. When the first input command and the second input command are to drag and drop the first graph and the second graph into the graph comparison area respectively, the control module controls the display device to display a third graph and display corresponding data of the first data and of the second data in juxtaposition or overlapped on the third graph.

Another aspect of the present disclosure is a graphical analysis method. According to an embodiment of the present disclosure, the graphical analysis method includes the following steps: displaying a first graph according to first data; displaying a second graph according to second data; receiving a first input command and a second input command, in which the first input command and the second input command are to drag and drop the first graph and the second graph into a graph comparison area respectively; displaying a third graph in response to the first input command and the second input command; and displaying corresponding data of the first data and of the second data in juxtaposition or overlapped on the third graph.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIGS. 1A-1C are diagrams illustrating a graphical analysis system according to an embodiment of the present disclosure;

FIGS. 2A-2F are diagrams illustrating the operations of a graphical analysis system according to an embodiment of the present disclosure;

FIGS. 3A-3C are diagrams illustrating the operations of a graphical analysis system according to an embodiment of the present disclosure;

FIG. 4 is a flow chart of a graphical analysis method according to an embodiment of the present disclosure;

FIG. 5 is a flow chart of a graphical analysis method according to an embodiment of the present disclosure; and

FIG. 6 is a flow chart of a graphical analysis method according to an embodiment of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. In the following embodiments and the accompanying drawings, components which are not directly related to the disclosure are omitted for the sake of brevity. The size ratio between elements in the accompanying drawings is only used for understanding, and not meant to limit the actual embodiments of the present disclosure in scale. Wherever possible, the same reference numbers are used in the drawings and the description to refer to the same or like parts for better understanding.

In the following description and in the claims, the terms “include” and “comprise” are used in an open-ended fashion, and thus should be interpreted to mean “include, but not limited to . . . ”.

The terms “first”, “second”, . . . etc., in the article do not refer to any specific order, nor intended to limit the present disclosure, it is only used for distinguishing the differences between components or operations with the same technological description.

Also, the term “coupled” or “connected” may refer to two or more elements are in direct physical or electrical contact, or in indirect physical or electrical contact via other devices and connections, and the term “coupled” may also refer to two or more elements cooperate or interact with each other.

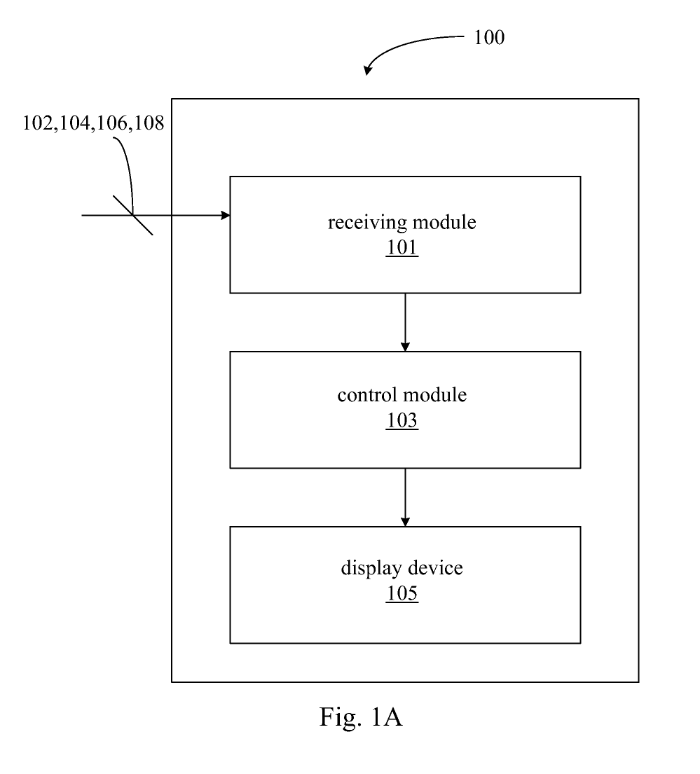

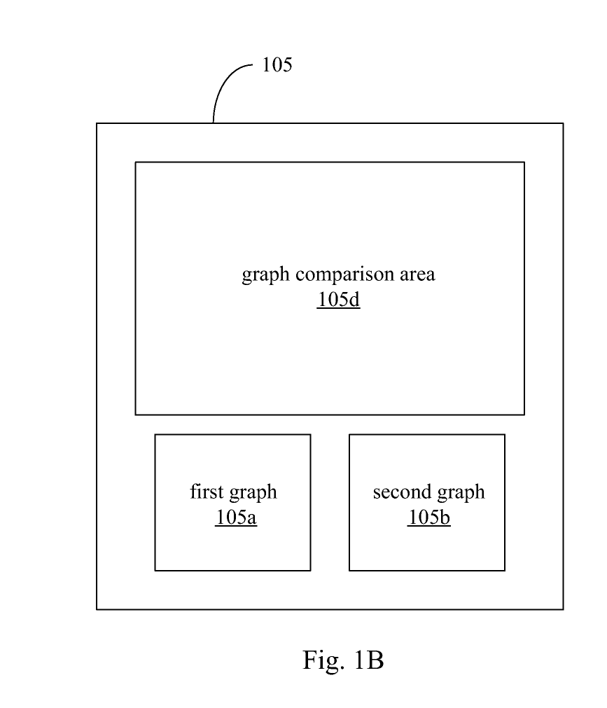

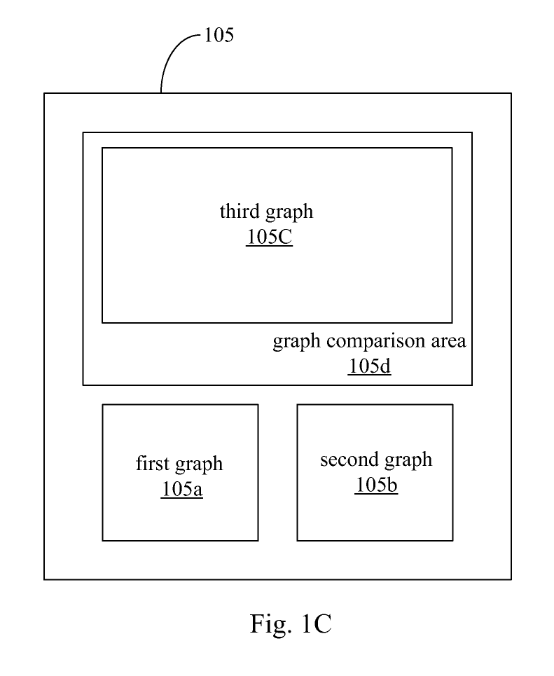

FIG. 1A is a diagram illustrating a graphical analysis system 100 according to an embodiment of the present disclosure. In the present embodiment, the graphical analysis system 100 includes a receiving module 101, a control module 103 and a display device 105. Referring to FIG. 1B in conjunction with FIG. 1A, the display device 105 is configured to display a plurality of graphs (e.g., a first graph 105a, a second graph 105b, and a graph comparison area 105d.) Specifically, the display device 105 displays the first graph 105a according to first data, and displays the second graph 105b according to second data. The first data and the second data may be any numeric data or statistics, and may also be inputted from other chart formats.

In the present embodiment, the receiving module 101 is configured to receive a first input command 102 and a second input command 104, and the receiving module 101 may be any device which may be configured to input signals, such as mouse, touch screen, touch panel, or any device having operative input functions. The control module 103 is coupled to the receiving module 101 and the display device 105, and is configured to control the display device 105 according to the first input command 102 and the second input command 104 received by the receiving module 101.

As shown in FIG. 1B, the graph comparison area 105d is displayed on a screen of the display device 105. When the first graph 105a is to be dragged and dropped into the graph comparison area 105d, the first input command 102 is configured to drag and drop the first graph 105a into the graph comparison area 105d. Likewise, when the second graph 105b is to be dragged and dropped into the graph comparison area 105d, the second input command 104 is configured to drag and drop the second graph 105b into the graph comparison area 105d.

In the present embodiment, as shown in FIG. 1 C, the control module 103 is configured, in response to the first input command 102 and the second input command 104, such that the second graph 105b and the first graph 105a are overlapped in the graph comparison area 105d. In other words, the first graph 105a and the second graph 105b are respectively or simultaneously dragged and dropped into the graph comparison area 105d, and the display device 105 is configured to display a third graph 105c in the graph comparison area 105d and display corresponding data of the first data and of the second data in juxtaposition or overlapped on the third graph 105c. In the present embodiment, the control module 103 may be implemented by a Central Processing Unit (CPU), a microprocessor, or other suitable computing devices.

In another embodiment, when the control module 103 is configured in response to the first input command 102 and the second input command 104 such that the second graph 105b and the first graph 105a are overlapped in the graph comparison area 105d, the control module 103 is further configured to adjust the second graph 105b from having a first transparency to having a second transparency. Specifically, when the first graph 105a and the second graph 105b are sequentially dragged and dropped into the graph comparison area 105d, the control module 103 is configured to control the display device 105 such that the second data of the second graph 105b is overlapped on the first data of the first graph 105a in a semi-transparent manner. On the other hand, when the first graph 105a is dragged and dropped into the graph comparison area 105d and overlapped on the second graph 105b, the control module 103 is configured to control the display device 105 such that the first graph 105a is adjusted from having a first transparency to having a second transparency, alternatively stated, the first graph 105a is displayed overlapped in a semi-transparent manner on the second graph 105b.

In the following paragraphs a plurality of embodiments are disclosed for achieving the functions and operations of the aforementioned graphical analysis system 100; however, the present disclosure is not limited by the following embodiments.

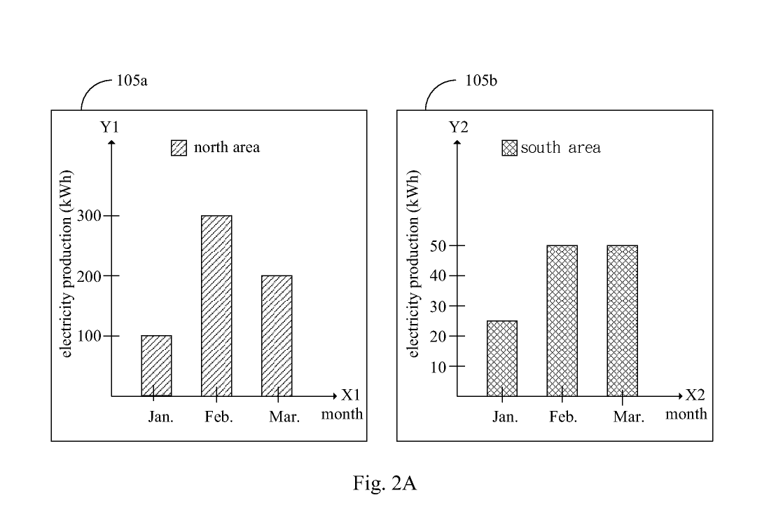

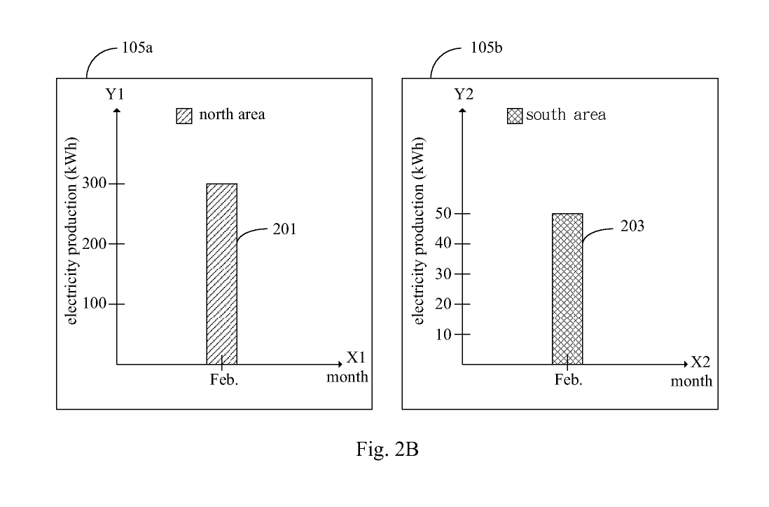

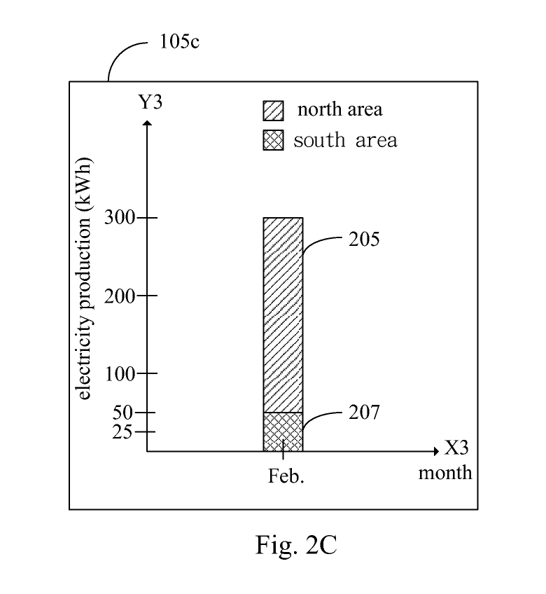

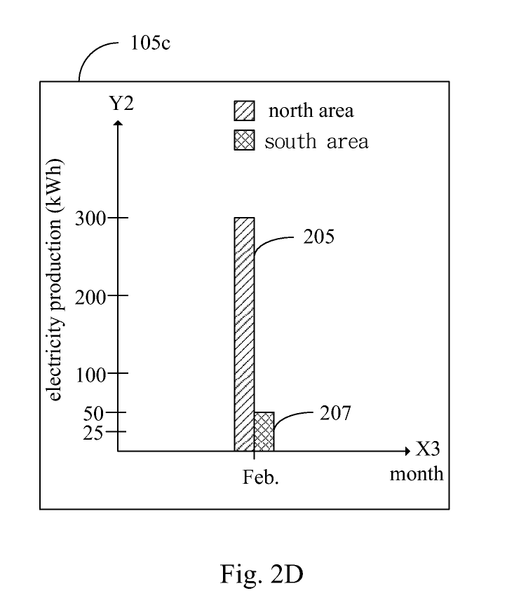

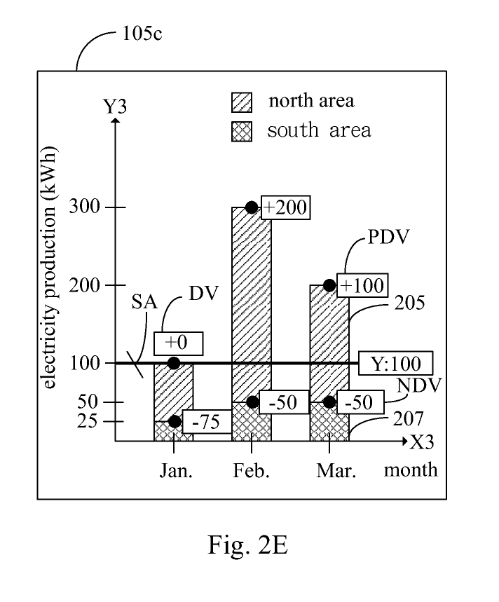

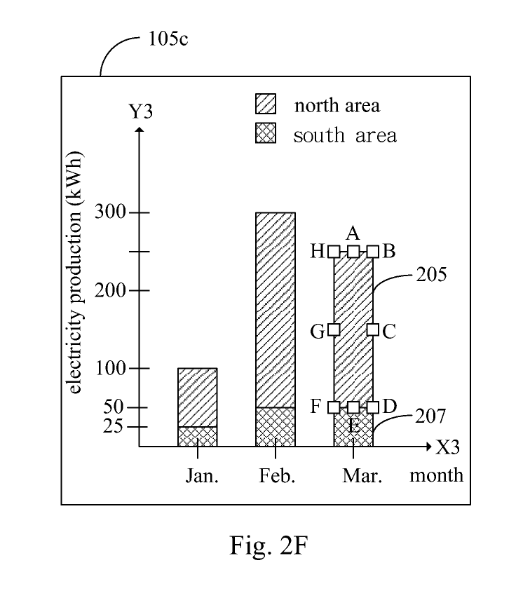

FIGS. 2A-2F are operational diagrams of the graphical analysis system 100 according to an embodiment of the present disclosure. For convenience and clarity of illustration, the following descriptions simultaneously refer to FIGS. 1A-1C and FIGS. 2A-2F.

For instance, the graphical analysis system 100 may be used for the data analysis of regional electricity production. As shown in FIG. 2A, at this time the aforementioned first data may be the electricity production (kWh) of the north area from January to March, and the aforementioned second data may be the electricity production (kWh) of the south area from January to March. After the control module 103 receives the first data and the second data, the control module 103 transmits the signal indicative of the first data and the signal indicative of the second data to the display device 105 respectively, and is configured such that the display device 105 displays the first graph 105a and second graph 105b according to the first data and the second data, respectively.

Referring to FIG. 2A, the first graph 105a and the second graph 105b are bar graphs, respectively. The first graph 105a includes a first X-axis X1 and a first Y-axis Y1, and the first graph 105a includes at least one first bar, at this time the definition of the first X-axis X1 and the definition of the first Y-axis Y1 of the first graph 105a are indicative of the month and the electricity production (kWh), respectively. On the other hand, the second graph 105b includes a second X-axis X2 and a second Y-axis Y2, and the second graph 105b includes at least one second bar; at this time the definition of the second X-axis X2 and the second Y-axis Y2 of the second graph 105b are indicative of the month and the electricity production (kWh), respectively.

In the present embodiment, for the sake of the brevity, only the electricity production (kWh) of the north area in February and the electricity production (kWh) of the south area in February are used for explanation. As shown in FIG. 2B, a first X-axis coordinate of the first bar 201 on the first graph 105a has a same or corresponding definition of a second X-axis coordinate of the second bar 203 on the second graph 105b. For instance, month is the unit for both the first X-axis coordinate and the second X-axis coordinate, and both of the first X-axis coordinate and the second X-axis coordinate are corresponding to the same month (i.e., February). It is noted that the amount of the first bar 201 on the first graph 105a and the amount of the second bar 203 on the second graph 105b are used for illustrative purposes only and are not meant to be limitations of the present disclosure.

First, the first graph 105a is to be dragged and dropped into the graph comparison area 105d, and the first input command 102 is configured to drag and drop the first graph 105a into the graph comparison area 105d. The control module 103 is configured in response to the first input command 102 to drag and drop the first graph 105a into the graph comparison area 105d. Then, when the second graph 105b is to be dragged and dropped into the graph comparison area 105d, the second input command 102 is configured to drag and drop the second graph 105b into the third graph 105c, such that the second graph 105b and the first graph 105a are overlapped.

Referring to FIG. 2C, the control module 103 is configured, in response to the first input command 102 and the second input command 104, such that the display device 105 displays the first bar 201 as a third bar 205 on the third graph 105c according to the first graph 105a, and displays the second bar 203 as a fourth bar 207 on the third graph 105c according to the second graph 105b.

Specifically, the third bar 205 is formed according to the first bar 201, and the fourth bar 207 is formed according to the second bar 203. When the first X-axis coordinate of the first bar 201 is corresponding to the second X-axis coordinate of the second bar 203, the display device 105 displays the third bar 205 and the fourth bar 207 overlapped at a same position of a third X-axis X3 on the third graph 105c.

Alternatively stated, both the first bar 201 and the second bar 203 are the electricity production in February, and both the corresponding X-axis coordinate are indicative of February. The third bar 205 and the fourth bar 207 are displayed and overlapped at a same position (i.e., February) at the third X-axis X3 on the third graph 105c, and the fourth bar 207 is displayed on the third bar 205 in a semi-transparent manner.

In another embodiment, as shown in FIG. 2D, when the first X-axis coordinate of the first bar 201 is corresponding to the second X-axis coordinate of the second bar 203 (i.e., both are indicative of February), the display device 105 may be further configured to display the third bar 205 and the fourth bar 207 in juxtaposition at a same position of the third X-axis X3 on the third graph 105c.

In another embodiment, when the first X-axis coordinate of the first bar 201 is not corresponding to the second X-axis coordinate of the second bar 203, the third bar 205 and the fourth bar 207 are displayed at different positions on the third graph 105c, respectively.

In an embodiment, the definitions of the third X-axis X3 and the third Y-axis Y3 on the third graph 105c are based on the definitions of the X-axis and the Y-axis of the graph which is first dragged and dropped into the graph comparison area 105d as bases. For instance, when the first graph 105a is the first to be dragged and dropped into the graph comparison area 105d, the definitions of the third X-axis X3 and the third Y-axis Y3 on the third graph 105c are based on the definitions of the first X-axis X1 and the first Y-axis Y1 of the first graph 105a as bases; on the other hand, when the second graph 105b is the first to be dragged and dropped into the graph comparison area 105d, the definitions of the third X-axis X3 and the third Y-axis Y3 on the third graph 105c are based on the definitions of the second X-axis X2 and the second Y-axis Y2 of the second graph 105b as bases.

In another embodiment, the control module 103 is configured, in response to the first input command 102 and the second input command 104, such that the display device 105 displays the scale of the third Y-axis Y3 of the third graph 105c according to the scale of the first Y-axis Y1 of the first graph 105a and the scale of the second Y-axis Y2 of the second graph 105b, and adjusts the fourth bar 207.

Specifically, referring to FIG. 2B and FIG. 2C, the first graph 105a herein is the first one to be dragged and dropped into the graph comparison area 105d, and the third graph 105c is configured such that the definitions of the third X-axis X3 and the third Y-axis Y3 on the third graph 105c are based on the definitions of the first X-axis X1 and the first Y-axis Y1 of the first graph 105a as bases. At this time a scale of the third Y-axis Y3 of the third graph 105c is configured to be the same as the scale of the first Y-axis Y1. Then, when the second graph 105b is then dragged and dropped into the graph comparison area 105d, since the scale of the second Y-axis Y2 of the second graph 105b differs from the scale of the first Y-axis Y1 of the first graph 105a (e.g., the electricity production indicated on the Y axis per unit of the second graph differs from that of the first graph), alternatively stated, the scale of the first Y-axis Y1 and the scale of the second Y-axis Y2 are based on different measurement bases (as shown in FIG. 2B), the second bar 203 of the second graph 105b may be adjusted according to the scale of the first Y-axis Y1 (as shown in FIG. 2C). In other words, the second bar 203 of the second graph 105b is dynamically scaled, alternatively stated, the second bar 203 is scaled proportionally according to the scale of the first Y-axis Y1.

In another embodiment, the receiving module 101 is further configured to receive a third input command 106, the control module 103 is further configured, in response to the third input command 106, such that the display device 105 displays a standard axis on the third graph 105c. In the present embodiment, the aforementioned standard axis is corresponding to the third Y-axis Y3 of the third graph 105c, and the control module 103 is further configured in response to the third input command 106 to calculate a standard value of the standard axis corresponding to the third Y-axis Y3, and configured such that the display device 105 displays the difference of the third bar of the third graph 105c compared to the standard value.

For instance, referring to FIG. 2E, the third graph 105c displays the electricity production of the north area and of the south area from January to March. In the present embodiment, the standard axis SA is corresponding to the third Y-axis Y3 of the third graph 105c, such as electricity production 100 kWh (as the standard value Y shown in FIG. 2E). Taking the electricity production in March as an example, when the control module 103 determines that the aforementioned standard value Y (e.g., 100) is larger than the largest value (e.g., 50 kWh) of the fourth bar 207 of the third graph 105c, the display device 105 is configured to display a negative difference value NDV (e.g., −50 kWh); on the other hand, when the control module 103 determines that the aforementioned standard value Y (e.g., 100) is smaller than the largest value (e.g., 200 kWh) of the third bar 205 of the third graph 105c, the display device 105 is configured to display a positive difference value PDV (e.g., +100 kWh). When the control module 103 determines the standard value Y (e.g., 100) is equal to the largest value of the third bar and/or the fourth bar, the display device 105 is configured to display a zero difference value DV. (e.g., +0 kWh)

In another embodiment, the receiving module 101 is further configured to receive a fourth input command 108. When the fourth input command 108 is configured to drag one of the third bar and connect it to any bar of the at least one fourth bar, the control module 103 is further configured in response to the fourth input command 108 to generate a first vector parameter corresponding to the length of the third bar 205, to generate a second vector parameter corresponding to the length of the fourth bar 207, and to sum up the first vector parameter and the second vector parameter.

For instance, referring to FIG. 2E and FIG. 2F, the electricity production of the north area in March is 200 kWh, and the electricity production of the south area in March is 50 kWh. For easier understanding of the total electricity production of the north area and the south area in March, the third bar 205 of the north area in March may be chosen, and the third bar 205 in March is dragged and dropped into the fourth bar 207 in March and connected with the fourth bar 207. As shown in FIG. 2F, when the third bar 205 is chosen, eight vertices A-H are displayed, and each of the vertices is corresponding to a coordinate position, and the first vector value of the third bar 205 is calculated by the control module 103 according to the coordinate positions of the eight vertices A-H. When the third bar 205 is to be dragged, the coordinate positions of the eight vertices A-H of the third bar 205 differ accordingly, while the first vector value is kept the same.

On the other hand, since the fourth bar 207 in March is not selected and the coordinate position of the fourth bar 207 is kept the same, only the third bar 205 in March is dragged and dropped into the fourth bar 207 and connected with the fourth bar 207. At this time, the control module 103 is configured to sum up the first vector value of the third bar 205 and the second vector value of the fourth bar 207, and thereby the total electricity production of the north area and the south area in March is calculated, which is 250 kWh. It is noted that the fourth bar 207 in March may also be chosen to be dragged and dropped. Since one of ordinary skill in the art can easily understand the aforementioned drag and drop operations, further description is therefore omitted for the sake of the brevity.

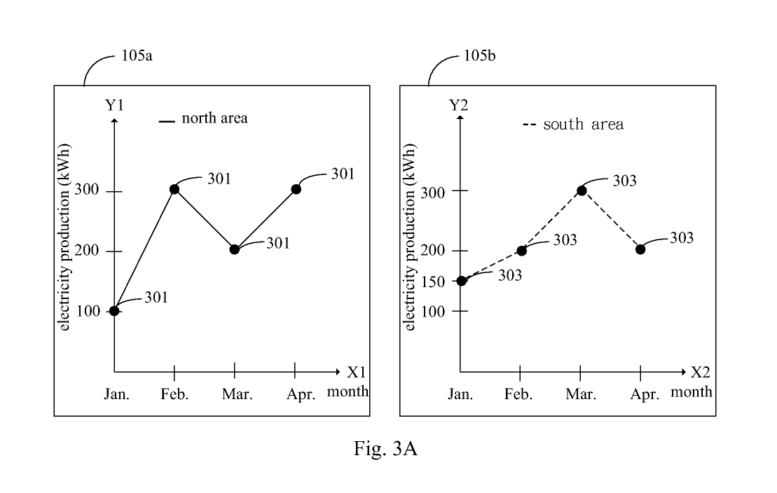

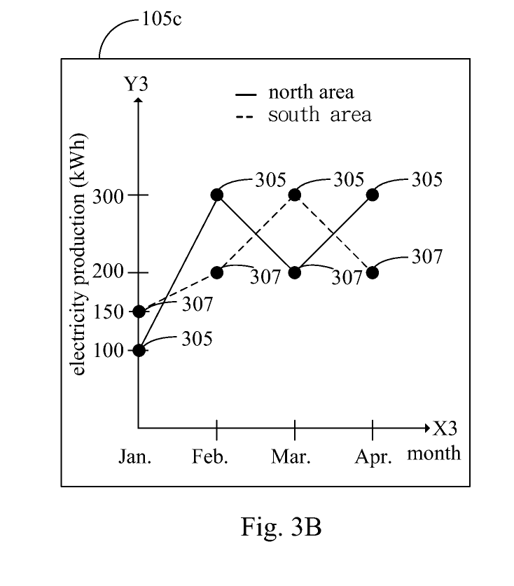

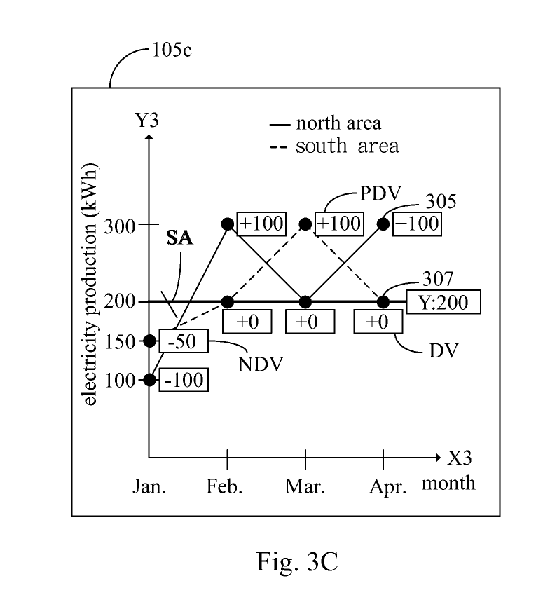

In addition, referring to FIGS. 3A-3C, FIGS. 3A-3C are diagrams illustrating the operations of the graphical analysis system 100 according to another embodiment of the present disclosure. To be described in a clear and concise manner, the following descriptions are explained in conjunction with the embodiments of the FIGS. 1A-1C and of the FIGS. 3A-3C. In the following paragraphs, the application of the aforementioned operational manner and system to the line graphs is explained.

In the embodiment illustrated in FIGS. 3A-3C, the first graph 105a and the second graph 105b are line graphs, respectively. The first graph 105a includes the first X-axis X1 and the first Y-axis Y1, and the first graph 105a further includes at least one first data point 301, at this time the definitions of the first X-axis X1 and the first Y-axis Y1 on the first graph 105a are indicative of month and electricity production (kWh), respectively. On the other hand, the second graph 105b includes the second X-axis X2 and the second Y-axis Y2, and the second graph 105b further includes at least one second data point 303, at this time, the definitions of the second X-axis X2 and the second Y-axis Y2 on the second graph 105b are indicative of month and electricity production (kWh), respectively.

In the present embodiment, the first X-axis coordinate of the first data point 301 on the first graph 105a has the same or corresponding definition of the second X-axis coordinate of the second data point 303 on the second graph 105b. In other words, month is the unit for both the first X-axis coordinate and the second X-axis coordinate, and both the first X-axis coordinate and the second X-axis coordinate are corresponding to the same months (i.e., from January to April). It is noted that the amount of the first data point 301 on the first graph 105a and the amount of the second data point 303 on the second graph 105b are used for the illustrative purposes only, and are not meant to be limitations of the present disclosure.

Referring to FIG. 3B, the control module 103 is configured in response to the first input command 102 such that the display device 105 displays the first data point 301 as a third data point 305 on the third graph 105c according to the first graph 105a, and configured in response to the second input command 104 such that the display device 105 displays the second data point 303 as the fourth data point 307 on the third graph 105c according to the second graph 105b. In addition, when the first X-axis coordinate of the first data point 301 is corresponding to the second X-axis coordinate of the second data point 303, the display device 105 is configured to display the third data point 305 and the fourth data point 307 at the same position of the third X-axis X3 on the third graph 105c.

In the present embodiment, the control module 103 is configured such that drag and drop the first graph 105a into the graph comparison area 105d in response to the first input command 102 first, and then drag and drop the second graph 105b into the graph comparison area 105d in response to the second input command 104 such that the second graph 105b is overlapped on the first graph 105a. When the first graph 105a is first dragged and dropped into the graph comparison area 105d, the definitions of the third X-axis X3 and the third Y-axis Y3 on the third graph 105c are based on the definitions of the first X-axis X1 and the first Y-axis Y1 on the first graph 105a as bases. In the present embodiment, the first X-axis X1 and the first Y-axis Y1 on the first graph 105a have same definitions to those of the second X-axis X2 and the second Y-axis Y2 on the second graph 105b.

Specifically, as shown in FIG. 3B, firstly, the first graph 105a is dragged and dropped into the third graph 105c first, thus the definitions of the third X-axis X3 and the third Y-axis Y3 on the third graph 105c are based on the definitions of the first X-axis X1 and the first Y-axis Y1 on the first graph 105a. At this time, the scale of the third Y-axis Y3 on the third graph 105c is the same as the scale of the first Y-axis Y1. Then, when the second graph 105b is dragged and dropped into the graph comparison area 105d, since the scale of the second Y-axis Y2 on the second graph 105b is the same as the scale of the first Y-axis Y1 on the first graph 105a, alternatively stated, the scale of the second Y-axis Y2 and the scale of the first Y-axis Y1 have the same measurement basis, hence the third data point 305 and the fourth data point 307 are overlapped with each other and are corresponding to the same definition of the third X-axis X3 and the same scale of the third Y-axis Y3.

In another embodiment, the receiving module 101 is further configured to receive a third input command 106, and the control module 103 is further configured, in response to the third input command 106, such that the display device 105 displays a standard axis on the third graph 105c. In the present embodiment, the aforementioned standard axis is corresponding to the third Y-axis Y3 on the third graph 105c, and the control module 103 is further configured in response to the third input command 106 to calculate a standard value of the standard axis which is corresponding to the third Y-axis Y3, and configured such that the display device 105 displays the difference of the third data point 305 on the third graph 105c compared to the standard value.

For instance, referring to FIG. 3C, the third graph 105c illustrates the electricity production of the north area and the south area from January to April. In the present embodiment, the standard axis SA is corresponding to the third Y-axis Y3 on the third graph 105c, for instance, the electricity production 200 kWh (the standard value Y as illustrated in FIG. 3C). When the control module 103 determines that the aforementioned standard value is larger than the largest value of the third data point 305 and/or the fourth data point 307 on the third graph 105c, the display device 105 is configured to display a negative difference value NDV; when the control module 103 determines that the aforementioned standard value is smaller than the largest value of the third data point 305 and/or the fourth data point 307 on the third graph 105c, the display device 105 is configured to display a positive difference value PDV; in addition, when the control module 103 determines the standard value is equal to the largest value of the third data point 305 and/or the fourth data point 307 on the third graph 105c, the display device 105 is configured to display a zero difference value DV. It is noted that, the present disclosure may be applied to the aforementioned bar graphs and line graphs; in addition, the present disclosure may further be applied to other graphs, such as graphic graphs, floating bar charts, and/or Gantt charts; however, the present disclosure may also be applied to all the alterative charts, and the variations of the present disclosure fall within the scope of the present disclosure.

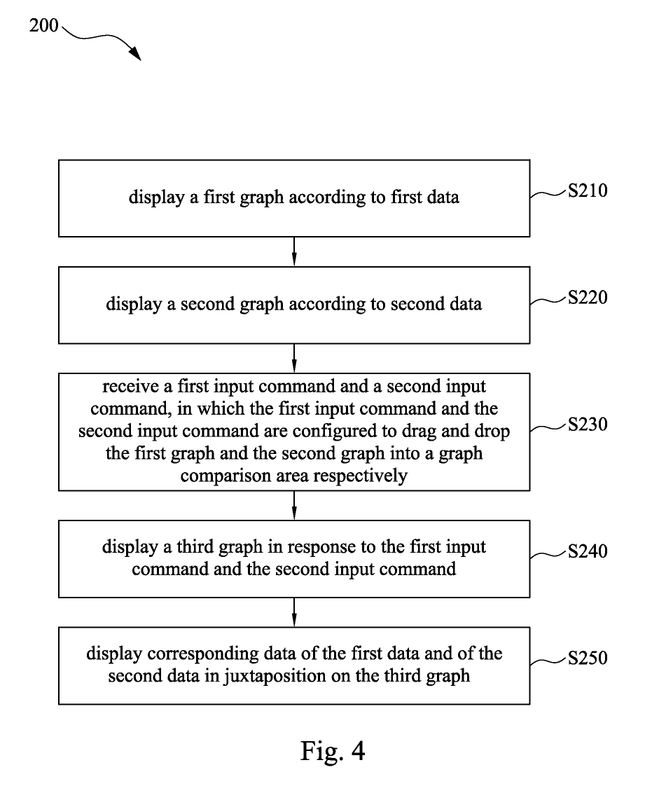

According to another aspect of the present disclosure, an operating method of a graphical analysis system 100 is provided. Referring to FIG. 4, FIG. 4 is a flow chart of a graphical analysis method 200 according to an embodiment of the present disclosure. As shown in FIG. 4, the graphical analysis method 200 includes Steps S210, S220, S230, S240 and S250.

In Step S210, a first graph is displayed according to first data. Then, in Step S220, a second graph is displayed according to second data. Next, in Step S230, a first input command and a second input command are received, in which the first input command and the second input command are configured to drag and drop the first graph and the second graph into a graph comparison area respectively. Then, in Step S240, a third graph is displayed in response to the first input command and the second input command. Finally, in Step S250, corresponding data of the first data and of the second data is displayed in juxtaposition on the third graph.

For instance, as shown in FIG. 2A and FIG. 2B, the first graph 105a includes at least one first bar, and the second graph 105b includes at least one second bar, and the third graph includes a third X-axis and a third Y-axis. The following steps are further included in step S250: the at least one first bar is displayed as at least one third bar on the third graph; and the at least one second bar is displayed as at least one fourth bar on the third graph.

In addition, when the first X-axis coordinate of the at least one first bar is corresponding to the second X-axis coordinate of the at least one second bar, the following step is further included in the graphical analysis method 200: the at least one third bar and the at least one fourth bar are displayed at a same position of the third X axis on the third graph.

In another embodiment, the following steps are further included in the graphical analysis method 200: the at least one fourth bar is adjusted such that the at least one third bar and the at least one fourth bar are corresponding to a scale of the third Y-axis.

In another embodiment, as shown in FIG. 3A and FIG. 3B, the first graph includes at least one first data point, and the second graph includes at least one second data point, and the third graph includes a third X-axis and a third Y-axis. The following steps are included in the step S250: the at least one first data point is displayed as at least one third data point on the third graph, and the at least one second data point is displayed as at least one fourth data point on the third graph.

In addition, when the first X-axis coordinate of the at least one first data point is corresponding to the second X-axis coordinate of the at least one second data point, the following step is further included in the graphical analysis method 200: the at least one third data point and the at least one fourth data point are displayed at a same position of the third X-axis on the third graph.

In another embodiment, the following steps are further included in the graphical analysis method 200: the at least one fourth data point is adjusted such that the at least one third data point and the at least one fourth data point are corresponding to the scale of the third Y-axis.

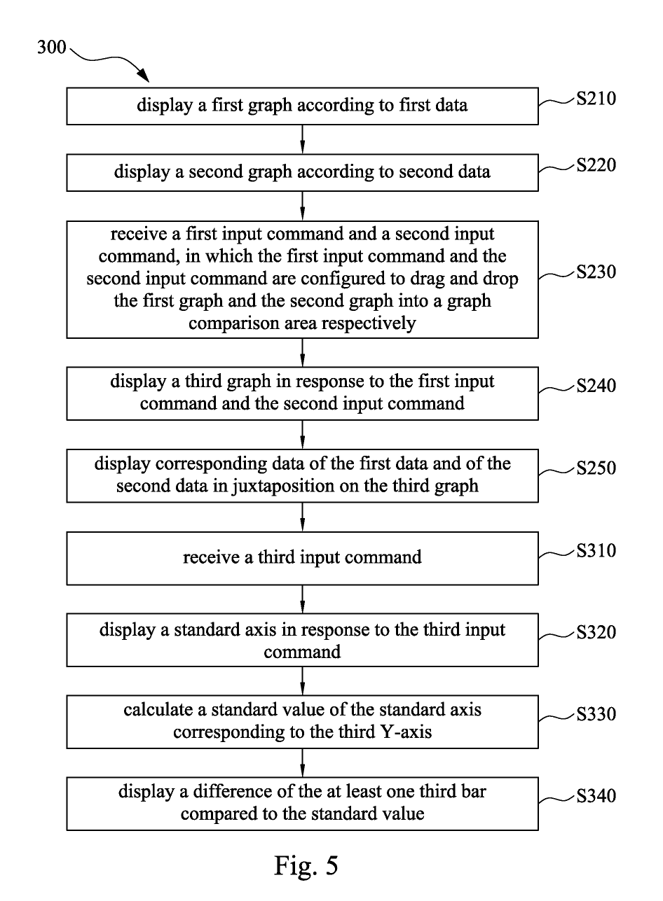

In another embodiment, referring to FIG. 5, in addition to the steps S210, S220, S230, S240, and S250, the steps S310, S320, S330 and S340 are further included in the graphical analysis method 300. Since the details of the steps S210, S220, S230, S240, and S250 have be disclosed in the aforementioned embodiments, further description is omitted here for the sake of brevity. In Step S310, the third input command is received. Next, in Step S320, a standard axis is displayed in response to the third input command. Then, in Step S330, a standard value of the standard axis corresponding to the third Y-axis is calculated. Finally, in Step S340, the difference of the at least one third bar compared to the standard value is displayed.

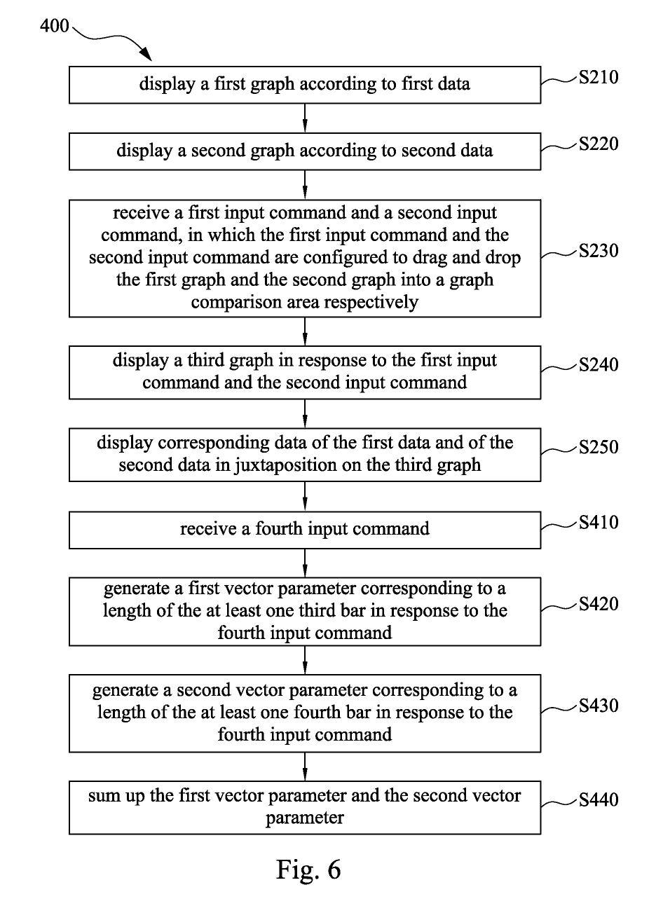

In another embodiment, referring to FIG. 6, in addition to the steps S210, S220, S230, S240, and S250, the steps S410, S420, S430, S440 and S450 are further included in the graphical analysis method 400. Since the details of the steps S210, S220, S230, S240, and S250 have be disclosed in the aforementioned embodiments, further description is omitted here for the sake of brevity. In step S410, a fourth input command is received. Next, in step S420, a first vector parameter corresponding to a length of the at least one third bar is generated in response to the fourth input command. Then, in step S430, a second vector parameter corresponding to a length of the at least one fourth bar is generated in response to the fourth input command. Finally, in step S440, the first vector parameter and the second vector parameter are summed up.

It is noted that in embodiments of the present disclosure, the steps S410, S420, S430 and S440 may be executed before or be executed after the steps S310, S320, S330 and S340. Since one of ordinary skill in the art can easily understand the operations and functions of the aforementioned graphical analysis method 200, 300 and 400, further description is therefore omitted for the sake of the brevity.

In addition, any one of the aforementioned graphical analysis method 200, 300 and 400 may be implemented respectively by a non-transitory computer readable recording medium having embodied a program. The program causes the computer to execute the graphical analysis method 200, 300 and 400, respectively, when executed by a computer. In the present embodiment, the aforementioned computer readable recording medium may be implemented by a general electronic device, such as read-only memory (ROM), flash memory, floppy disks, hard disks, CDs, USB disks, tapes, any other storage mediums which may access the databases over the internet, or any other storage mediums with the same function known by one of ordinary skill in the art.

From the aforementioned embodiments, it is known that in the present disclosure, by the manner of dragging and dropping graphs, the graphs to be compared are putted together directly, the differences between graphs are displayed in the manner of juxtaposition or overlapped, the difference of data in the graphs is calculated through a standard value, and the data between different data groups is further summed up. Thus, not only the time of manual calculations is saved, but also deviations in calculated results due to human error are avoided.

Although the present disclosure has been described in considerable detail with reference to certain embodiments thereof, other embodiments are possible. Therefore, the spirit and scope of the appended claims should not be limited to the description of the embodiments contained herein. It is apparent to one of ordinary skill in the art that various modifications and variations can be made to the structure of the present disclosure without departing from the scope or spirit of the disclosure. In view of the foregoing, it is intended that the present disclosure cover modifications and variations of the present disclosure provided they fall within the scope of the following claims.

What is claimed is:

1. A graphical analysis system, comprising:
a display device configured to display a first graph, a second graph and a graph comparison area, wherein the display device displays the first graph according to first data and displays the second graph according to second data;
a receiving module configured to receive a first input command and a second input command; and
a control module configured in response to the first input command and the second input command, such that when the first input command and the second input command are configured to drag and drop the first graph and the second graph into the graph comparison area respectively, the control module controls the display device to display a third graph and display corresponding data of the first data and of the second data in juxtaposition or overlapped on the third graph.

2. The graphical analysis system of claim 1, wherein the first graph and the second graph are bar graphs, and the first graph comprises a first X-axis, a first Y-axis and at least one first bar, and
the second graph comprises a second X-axis, a second Y-axis and at least one second bar, and a first X-axis coordinate of the at least one first bar has a same or corresponding definition of a second X-axis coordinate of the at least one second bar;
wherein the control module is configured in response to the first input command such that the display device displays the at least one first bar as at least one third bar on the third graph according to the first graph and displays the at least one second bar as at least one fourth bar on the third graph according to the second graph, and when the first X-axis coordinate of the at least one first bar is corresponding to the second X-axis coordinate of the at least one second bar, the display device is configured to display the at least one third bar and the at least one fourth bar in juxtaposition or overlapped at a same position of a third X-axis on the third graph.

3. The graphical analysis system of claim 2, wherein the control module is configured, in response to the first input command, such that the display device displays the scale of a third Y-axis according to the scale of the first Y-axis of the first graph and adjusts the at least one fourth bar according to the scale of the second Y-axis of the second graph.

4. The graphical analysis system of claim 2, wherein the receiving module is further configured to receive a third input command, the control module is further configured, in response to the third input command, such that the display device displays a standard axis, and the standard axis is corresponding to the third Y-axis of the third graph, and the control module is configured in response to the third input command to further calculate a standard value of the standard axis corresponding to the third Y-axis; and
the control module is further configured to control the display device such that the display device displays the difference of the at least one third bar compared to the standard value.

5. The graphical analysis system of claim 2, wherein the receiving module is further configured to receive a fourth input command, and when the fourth input command is configured to drag one bar of the at least one third bar and connect the bar with any one bar of the at least one fourth bar, the control module is further configured in response to the fourth input command to generate a first vector parameter corresponding to the length of the at least one third bar, to generate a second vector parameter corresponding to the length of the at least one fourth bar, and to sum up the first vector parameter and the second vector parameter.

6. The graphical analysis system of claim 1, wherein the first graph and the second graph are line graphs, and the first graph comprises a first X-axis, a first Y-axis, and at least one first data point, and the second graph comprises a second X-axis, a second Y-axis, and at least one second data point, and a first X-axis coordinate of the at least one first data point has a same or corresponding definition of a second X-axis coordinate of the at least one second data point;
wherein the control module is further configured, in response to the first input command, such that the display device displays the at least one first data point as at least one third data point on the third graph according to the first graph, and displays the at least one second data point as at least one fourth data point on the third graph according to the second graph, wherein when the first X-axis coordinate of the at least one first data point corresponds to the second X-axis coordinate of the at least one second data point, the display device is configured to display the at least one third data point and the at least one fourth data point at a same position of a third X-axis on the third graph.

7. The graphical analysis system of claim 6, wherein the control module is configured, in response to the first input command, such that the display device displays the scale of a third Y-axis according to the scale of the first Y-axis of the first graph and adjusts the at least one fourth data point according to the scale of the second Y-axis of the second graph.

8. The graphical analysis system of claim 6, wherein the receiving module is further configured to receive a third input command, the control module is further configured, in response to the third input command, such that the display device displays a standard axis, and the standard axis is corresponding to the third Y-axis of the third graph, and the control module is configured in response to the third input command to further calculate a standard value of the standard axis corresponding to the third Y-axis; and
the control module is further configured to control the display device such that the display device displays the difference of the at least one third data point compared to the standard value.

9. A graphical analysis method, comprising:
displaying a first graph according to first data;
displaying a second graph according to second data;
receiving a first input command and a second input command, wherein the first input command and the second input command are configured to drag and drop the first graph and the second graph into a graph comparison area respectively;
displaying a third graph in response to the first input command and the second input command; and
displaying corresponding data of the first data and the second data in juxtaposition or overlapped on the third graph.

10. The graphical analysis method of claim 9, wherein the first graph comprises at least one first bar, and the second graph comprises at least one second bar, and the third graph comprises a third X-axis and a third Y-axis; the steps of displaying corresponding data of the first data and of the second data in juxtaposition or overlapped on the third graph comprises:
displaying the at least one first bar as at least one third bar on the third graph; and
displaying the at least one second bar as at least one fourth bar on the third graph;
wherein when the first X-axis coordinate of the at least one first bar corresponds to the second X-axis coordinate of the at least one second bar, the graphical analysis method further comprising:
displaying the at least one third bar and the at least one fourth bar at a same position of the third X-axis on the third graph.

11. The graphical analysis method of claim 10, further comprising:
adjusting the at least one fourth bar such that the at least one third bar and the at least one fourth bar is corresponding to the scale of the third Y-axis.

12. The graphical analysis method of claim 10, further comprising:
receiving a third input command;
displaying a standard axis in response to the third input command;
calculating a standard value of the standard axis corresponding to the third Y-axis; and
displaying the difference of the at least one third bar compared to the standard value.

13. The graphical analysis method of claim 10, further comprising:
receiving a fourth input command;
generating a first vector parameter corresponding to the length of the at least one third bar in response to the fourth input command;
generating a second vector parameter corresponding to the length of the at least one fourth bar in response to the fourth input command; and
summing up the first vector parameter and the second vector parameter.

14. The graphical analysis method of claim 9, wherein the first graph comprises at least one first data point, the second graph comprises at least one second data point, and the third graph comprises a third X-axis and a third Y-axis; the steps of displaying corresponding data of the first data and of the second data in juxtaposition or overlapped on the third graph comprises:
displaying the at least one first data point as at least one third data point on the third graph; and
displaying the at least one second data point as at least one fourth data point on the third graph;
wherein when the first X-axis coordinate of the at least one first data point which the at least one third data point accords to corresponds to the second X-axis coordinate of the at least one second data point which the at least one fourth data point accords to, the graphical analysis method further comprises:
displaying the at least one third data point and the at least one fourth data point at a same position of the third X-axis on the third graph.

15. The graphical analysis method of claim 14, further comprising:
adjusting the at least one fourth data point such that the at least one third data point and the at least one fourth data point are corresponding to the scale of the third Y-axis.

16. The graphical analysis method of claim 14, further comprising:
adjusting the at least one fourth data point such that the at least one third data point and the at least one fourth data point is corresponding to the scale of the third Y-axis.

17. The graphical analysis method of claim 14, further comprising:
receiving a third input command;
displaying a standard axis in response to the third input command;
calculating a standard value of the standard axis corresponding to the third Y-axis; and
displaying the difference of the at least one third data point compared to the standard value.

18. A non-transitory computer readable recording medium having embodied thereon a program which, when executed by a computer, causes the computer to execute the method of claim 9.
